(19) United States
(12) Patent Application Publication
(10) Pub. No.: US 2011/0099102 A1
(43) Pub. Date: Apr. 28, 2011

(54) System and method for automated receipt and processing of donations

(76) Inventor: Robert Christopher Leffew, Markleville, IN (US)

(21) Appl. No.: 12/589,699

(22) Filed: Oct. 27, 2009

(51) Int. Cl. G06Q 99/00; G06Q 40/00

(52) U.S. Cl. 705/39; 705/329

(57) ABSTRACT

A web-based donation system is disclosed that is configured and operable to allow a sponsor to register or signup one or more recipients to receive funds from donors. The system is configured with a donor registration module that allows the donors to post solicitations for donations for respective recipients. The system is configured such that only businesses, and not individuals, can sponsor recipients. All funds received from donors are placed in a third party account until the period for solicitation of funds has ended. Upon conclusion, the funds are transferred anonymously to an account associated with the recipient.

### BACKGROUND

The present application relates generally to donations, and more particularly but not exclusively relates to a system and method for the automated handling and processing of donations to individuals and families experiencing life altering circumstances.

A number of organizations exist for the purpose of charitable and/or non-profit functions, including organizations which qualify as charitable organizations under U.S. Internal Revenue Service (IRS) Regulation 501(c)(3). Obviously, there are a number of costs associated with the handling and processing of donations. One such cost is the cost associated with hiring employees for the purpose of soliciting funds. Another cost associated with charitable organizations is the cost of handling and distributing the donated funds.

Currently, many methods exist to donate to various types of charities, such as point of purchase donations, online donations, mail in donations, and so forth. Known methods of donating to charities focus on donating to one or more types of charities that are focused on one particular thing, such as donating to fight breast cancer, leukemia, and diabetes, to name a few. Although these are very good causes, no known automated method exists to donate to people or families who are dealing with life altering events. These life altering events can include the loss of a loved one, illness, injury, child birth, natural disaster or any other life changing or devastating situation.

### SUMMARY

One embodiment is a unique system and method for setting up, receiving, and processing donations to people going through a life altering experience. Further embodiments, forms, objects, features, advantages, aspects, and benefits shall become apparent from the following description and drawings.

### BRIEF DESCRIPTION OF THE DRAWINGS

FIG. 1 is a block diagram of a donation management system.

FIG. 2 is a block diagram of certain components and structures of the donation management system.

FIG. 3 is an illustrative main web page generated by a web server of the donation management system.

FIG. 4 is an illustrative sponsor registration web page generated by the web server of the donation management system.

FIG. 5a is an illustrative web page generated by the web server for sponsors to sponsor individual recipients.

FIG. 5b is an illustrative web page generated by the web server for sponsors to sponsor individual recipients.

FIG. 5c is an illustrative web page generated by the web server for sponsors to sponsor individual recipients.

FIG. 6 is an illustrative sponsor payment web page generated by the web server.

FIG. 7 is an illustrative web page automatically generated by the donation management system for soliciting donations from donors for a recipient.

FIG. 8 is an illustrative donation web page generated for donors who would like to donate funds to a respective recipient.

FIG. 9 is an illustrative web page setting forth a representative search result for a donor attempting to locate a recipient.

FIG. 10 is an illustrative web page setting forth a representative search result for a donor attempting to locate a sponsor.

### DESCRIPTION OF ILLUSTRATIVE EMBODIMENTS

For purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated device, and such further applications of the principles of the invention as illustrated therein being contemplated as would normally occur to one skilled in the art to which the invention relates.

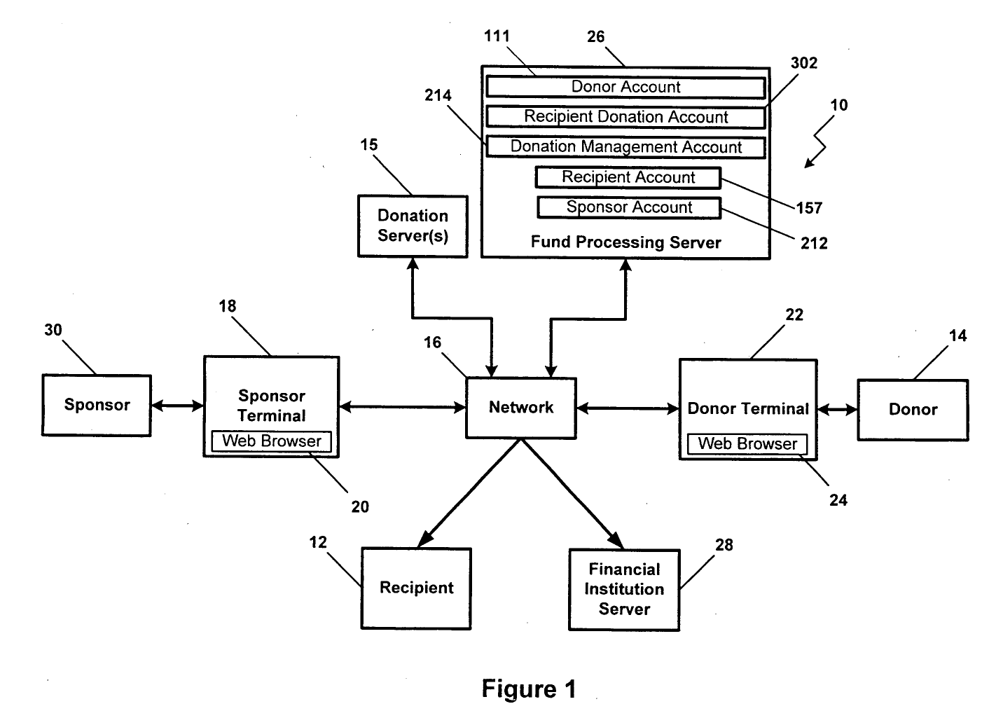

Referring to FIG. 1, a donation management system 10 is illustrated that is configured to provide financial assistance to individuals or families in need. In one form, donation management system 10 is a web-based system configured to provide an on-line forum where individuals or families 12 (hereinafter referred to as “recipients 12”) who are dealing with life altering circumstances (e.g.—death in the family, illness, injury, child birth, natural disaster, and so forth) can accept financial gifts from family, friends, neighbors, business entities, organizations, and so forth (hereinafter referred to collectively as “donors 14”). As such, the purpose of donation management system 10 is to lessen the financial burden that the recipients 12 might be facing as a result of their particular life altering circumstance.

The donation management system 10 includes one or more donation server(s) 15 that are configured to provide the services, content, and data set forth in greater detail below. The donation server 15 should be construed as a computer or device that is configured with various software applications, routines or modules that are configured to perform certain tasks. The donation server 15 is connected and in communication with a communication network 16. In one form, the communication network 16 comprises the Internet, but other types of communication networks may also be used.

A sponsor terminal or computing device 18 is also connected with the network 16. The sponsor terminal 18 could be a desktop computer, a laptop computer, a handheld computing device, a smartphone, or any other type of computing device. In one form, sponsor terminal 18 includes a web browser 20 that is configured to access various web pages over the network 16. In addition, browser 20 is also configured to run various applications that may be contained on web pages accessed over the network 16. A donor terminal or computing device 22 is also connected with the network 16. The donor terminal 22 may also include a web browser 24.

A fund processing server 26 is also connected and in communication with network 16. The fund processing server 26 is configured as an e-commerce server that allows funds to be transferred to and from various designated financial accounts. In one form, funds are funded to a designated account from a transaction card such as a bank card or a credit card. The fund processing server 26 is also configured to transfer money from one or more designated accounts to a recipient's financial account (e.g.—checking or savings account). A financial institution server 28 is also connected and in communication with network 16. In one form, the financial institution server 28 is configured to receive donated funds that are transferred from the fund processing server 26 and apply those funds to a recipient's financial account. In this form, the financial institution server 28 would service and be associated with a bank account of a respective recipient 12.

The donation management system 10 is operable to present sponsors 30 and donors 14 with a user interface in the form of a graphical set of interrelated screens. Through interactions with those screens, sponsors 30 can establish one or more accounts that are configured to solicit and accept donations for one or more designated recipients 12. The donors 14 can interact with the screens to search and locate a recipient 12 to which they want to give a donation. Once a recipient 12 is located, the screens allow the donor 14 to donate funds to the recipient 12 through web browser 24.

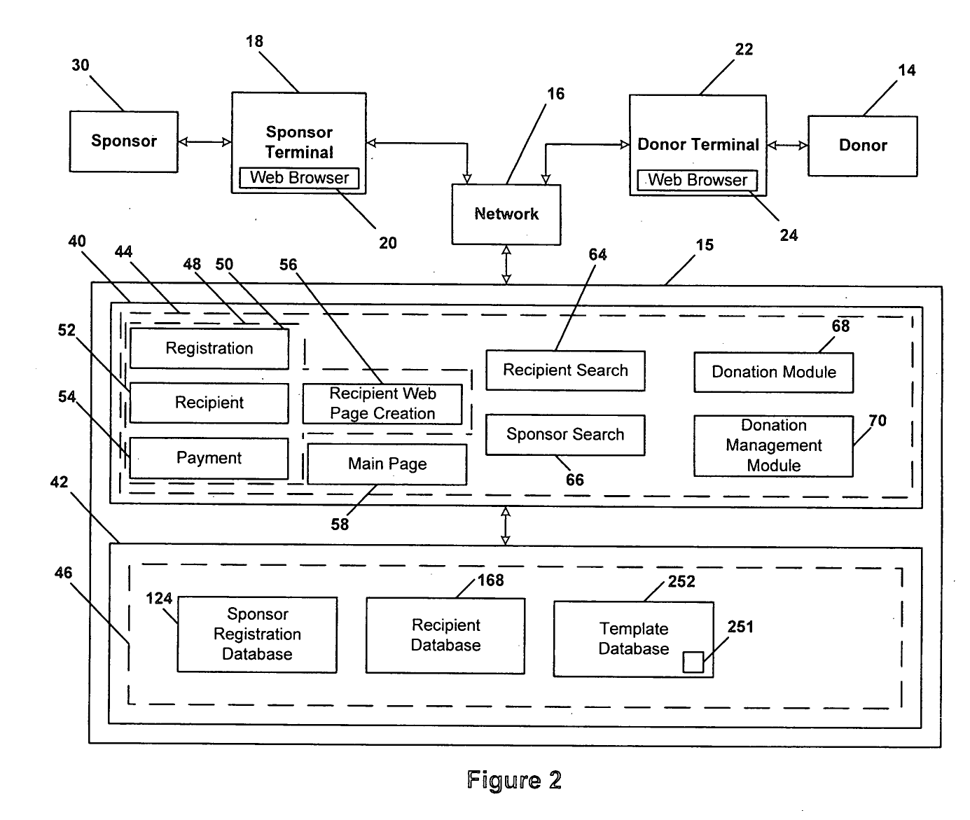

Referring to FIG. 2, a block diagram is illustrated of an exemplary embodiment of the donation management system 10 with which the sponsor 30 interacts to set up an account to solicit donations for a respective recipient 12. In one form, the sponsor 30 is a business or organization only. The business or organization may be a for-profit entity or a non-profit entity. No private or individual sponsors are allowed. As illustrated in FIG. 2, the sponsor 30 and donor 14 remotely access the donation management system 10 through the network 16 via web browsers 20, 24 on the sponsor terminals 18 and donor terminals 22.

The donation server(s) 15 may include one or more web server(s) 40 and one or more database servers 42. In another form, the donation server 15 is configured to act as both a web server and a database server. The web server 40 is configured to provide an interface through which both sponsors 30 and donors 14 communicate with the donation management system 10 via web browsers 20, 24. In one form, the web server 40 is configured with software that serves content to the web browsers 20, 24 on the sponsor terminal 18 and the donor terminal 22 using the hypertext transfer protocol (HTTP). This content can be in the form of hypertext mark-up language (HTML) documents, images, and other web resources, but can include any type of file. The content served by the web server 40 can be pre-existing (static content) or generated on the fly (dynamic content).

Web browsers 20, 24 are software applications used for retrieving, presenting, and traversing information that is provided by the web server 40. Web browsers 20, 24 also allow donors 14 and sponsors 30 to send data for storage to the donation management system 10. Web browsers 20, 24 could be selected from many web browsers currently available such as Windows Internet Explorer, Mozilla Firefox, Apple Safari, Google Chrome, and Opera. The primary purpose of the web browsers 20, 24 is to present content to the sponsor 30 and donor 14 from the web server 40 as well as to receive data from the sponsor 30 and donor 14. Aside from HTML documents, the web browsers 20, 24 can display any kind of content that can be part of a web page. In one form, the web browsers 20, 24 are configured to display images, web pages, audio, video, XML files, Active X modules, and also contain plug-ins that support Flash applications and Java applets.

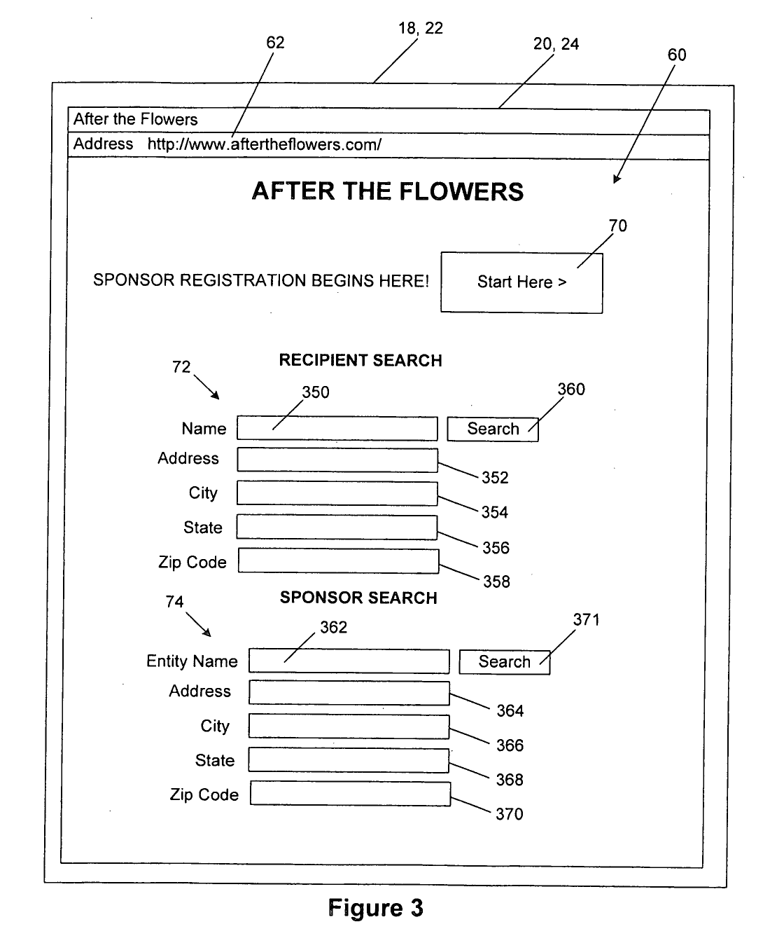

The web server 40 includes a number of user interface modules 44 that are stored on or in communication with web server 40. The user interface modules 44 interact with the database server 42 to access data 46 that is stored on the database server 42. In one form, the user interface modules 44 include a sponsor interface module 48 that includes a registration module 50, a recipient module 52, a payment module 54, and a recipient web page creation module 56, which will all be described in further detail below. The user interface modules 44 also include a main page module 58 that is configured to generate a main web page 60 (See FIG. 3) on the web browser 20, 24 of the sponsor terminal 18 and/or the donor terminal 22. The main web page 60 is accessed when either a sponsor 30 or donor 14 use a respective browser 20, 24 and enter a universal resource locator (URL) 62 (e.g.—www.aftertheflowers.com) associated with the donation management system 10.

The user interface modules 44 also include a recipient search module 64 and a sponsor search module 66. As set forth in greater detail below, the recipient search module 64 is configured and operable to allow donors 14 to search for and locate recipients 12 that have been added to the donation management system 10 by sponsors 30. The sponsor search module 66 is configured and operable to allow donors 14 to search for and locate sponsors 30, which will in turn allow the donors 14 to view recipients 12 that have been listed or sponsored by the sponsors 30. A donation module 68 is also included that is configured and operable to allow donors 14 to donate funds to respective recipients 12. A donation management module 70 is included that is configured to allow the operator of the donation management system 10 to monitor donations and payments to recipients 12 of funds donated through the donation management system 10.

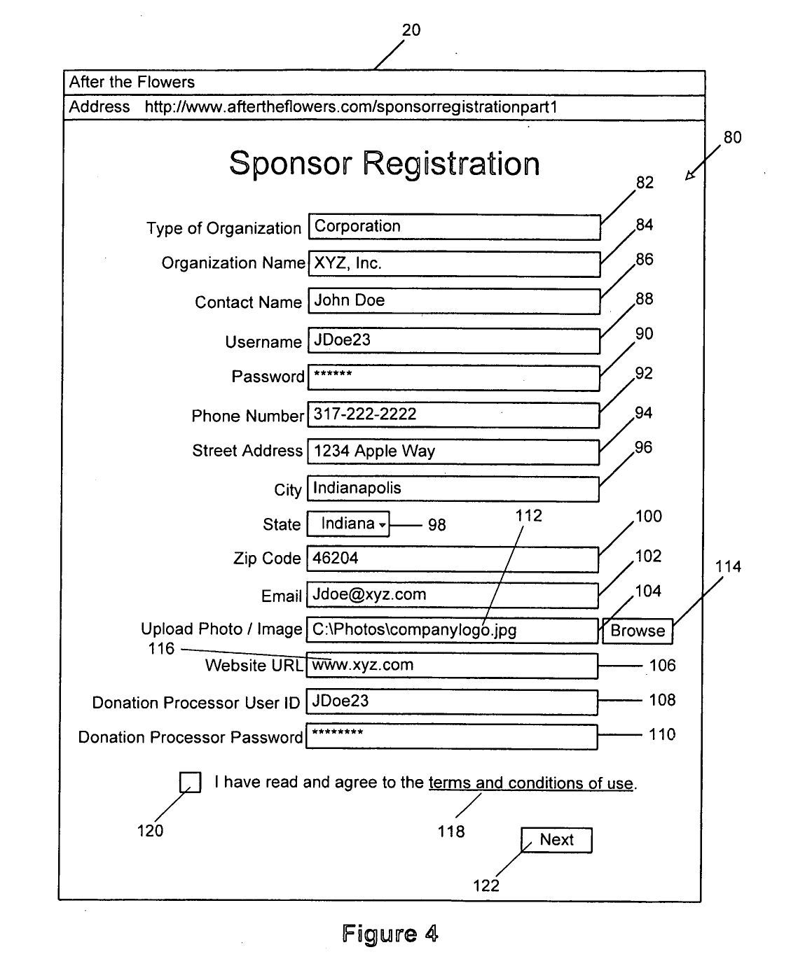

Referring to FIGS. 2 and 3, in one form the main web page 60 includes a sponsor registration link 70, a recipient search area 72, and a sponsor search area 74. If a sponsor 30 desires to sponsor or list a recipient 12, the sponsor 30 will select the sponsor registration link 70, which in turn will activate the sponsor registration module 50. As illustrated in FIG. 4, the sponsor registration module 50 is configured and operable to generate a sponsor registration web page 80 on the web browser 20 of the sponsor terminal 18. The content of the sponsor registration web page 80 is transmitted to the web browser 20 via the network 16.

As previously set forth, a sponsor 30 is a business or organization and no private or individual sponsors are allowed. The sponsor registration web page 80 includes a type of organization data field 82, an organization name data field 84, a contact name data field 86, a username data field 88, a password data field 90, a phone number data field 92, an address data field 94, a city data field 96, a state data field 98, a zip code data field 100, an email data field 102, an image upload data field 104, a website URL data field 106, a donation processor user identification data field 108, and a donation processor password data field 110. The type of organization data field 82 requires the sponsor 30 to designate the type of business entity that the sponsor 30 is designated as (e.g.—corporation, partnership, and so forth). The organization name data field 84 allows the sponsor 30 to enter their business name and the contact name data field 86 designates the individual at the sponsor 30 responsible for sponsoring a recipient 12.

The username data field 88 and password data field 90 requires the individual registering as a sponsor 30 to designate a username and password to gain access to an account that will be established for the sponsor 30 on the donation management system 10. The phone number data field 92, the street address data field 94, the city data field 96, the state data field 98, and the zip code data field 100 are all contact information associated with the sponsor 30. The email address data field 102 is the email address of the contact person of the sponsor 30.

The image upload data field 104 is automatically populated once the user designates an image 112 to be uploaded to the donation management system 10. A selection button 114 allows the user to select the image 112 to be uploaded to the donation management system 10 from the sponsor terminal 18. The image 112 could be a company logo or any other type of image that the sponsor 30 may choose to upload. The donation management system 10 is configured to accept several different types of image file formats such as, for example, JPEG, TIFF, GIFF, BMP, and PDF files. As set forth in greater detail below, the image 112 is placed on a web page that is created to solicit funds for the recipient 12, which allows the sponsor 30 to receive recognition.

The website URL data field 106 allows the sponsor 30 to enter a domain name 116 associated with the sponsor 30. As set forth in greater detail below, a link to the domain name 116 will appear on the web page that is created to solicit funds for the recipient 12 so that donors 14 can readily visit the website of the sponsor 30. The donation processor user ID data field 108 and donation processor password data field 110 are required entries. In order for a sponsor 30 to list and sponsor a recipient 12, the sponsor 30 is required to set up a recipient donation account 302 with the fund processing server 26. See FIG. 1. As set forth in greater detail below, the fund processing server 26 is configured to process financial transactions, in the form of donations in this instance, from various, types of financial transaction cards (e.g.—Visa, Mastercard, American Express, Discover) or from a donor account 111 on the fund processing server 26. In one form, the fund processing server 26 is operated by Paypal.

The sponsor registration web page 80 also includes a link 118 to the terms and conditions of use of the donation management system 10. The link 118 is configured and operable to generate a web page that displays the terms and conditions of use. A check box 120 is included that is required to be checked by the sponsor 30 in order to proceed. A next button 122 is included that upon selection by the sponsor 30 causes the web browser 20 to transmit all of the data entered by the sponsor 30 to the web server 40. The registration module 50 is configured to receive all of the information entered by the sponsor 30 in the various data fields, together with the uploaded image 112, and transmit it to a sponsor registration database 124 on the database server 42 for storage. See FIG. 2. The sponsor registration database 124 stores all of the information entered by the sponsor 30 together with the uploaded sponsor image 112.

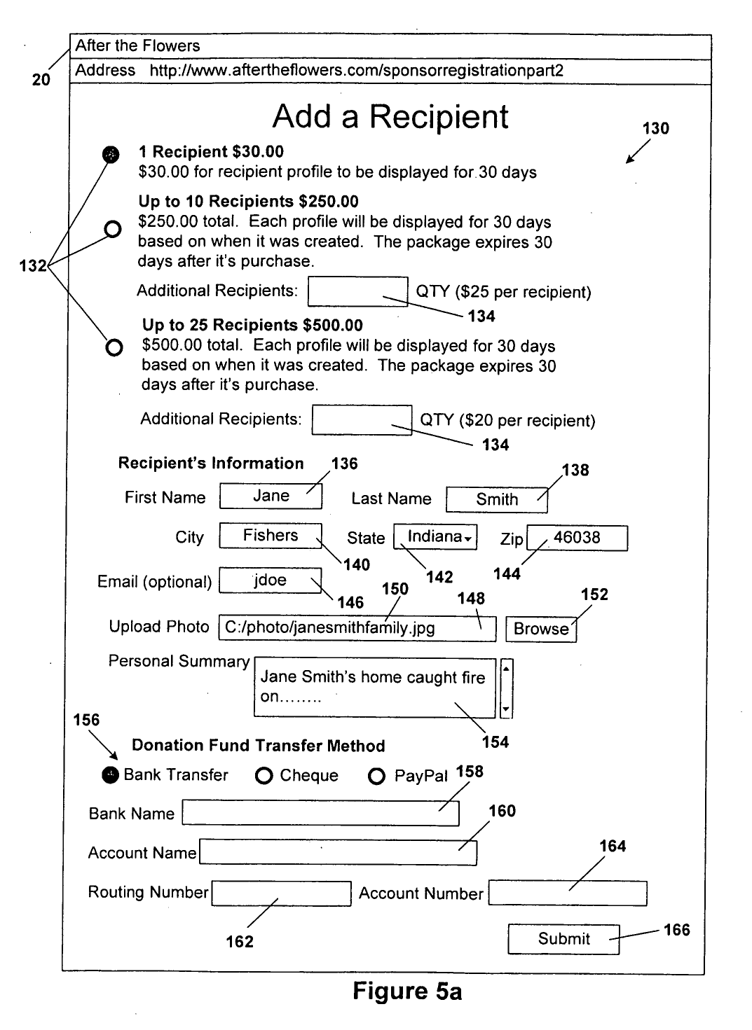

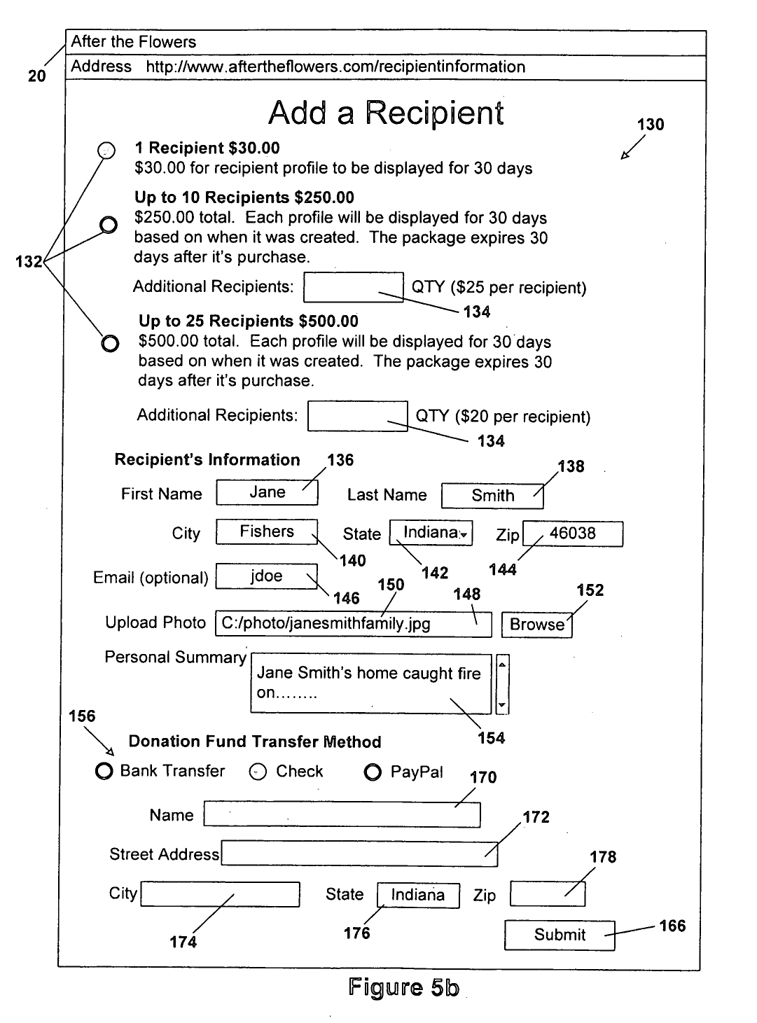

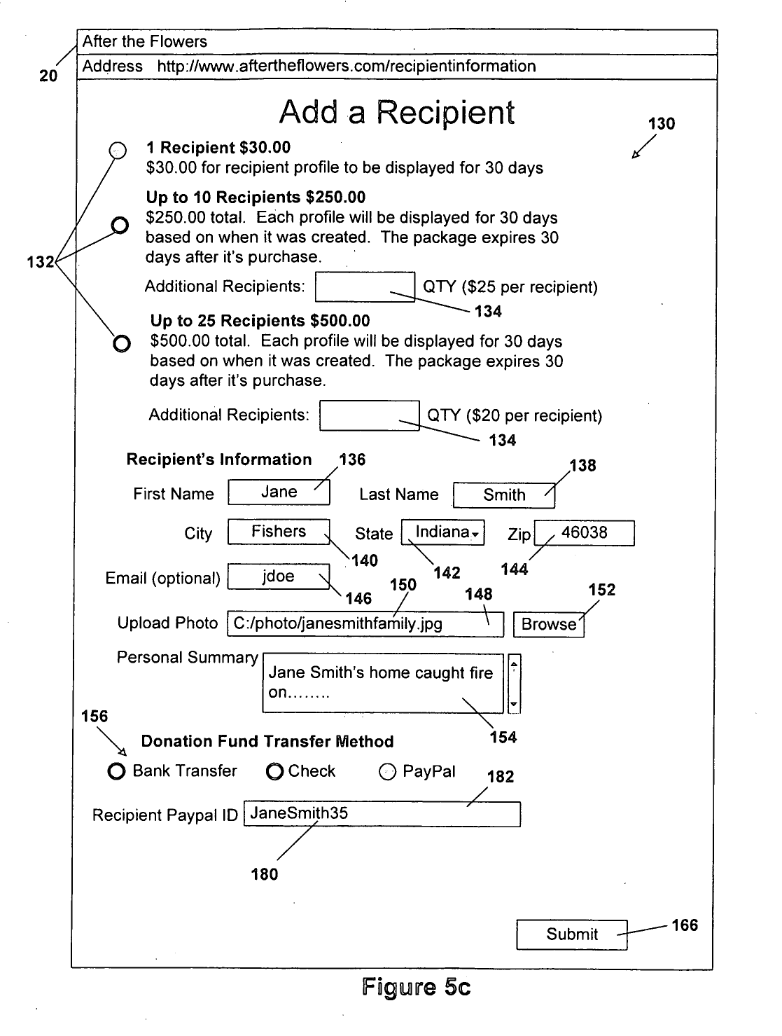

Upon receipt of the information and image 112, the recipient module 52 is executed which transmits a recipient designation web page 130 to the web browser 20 of the sponsor 30 over the network 16. As illustrated in FIG. 5a, the recipient designation web page 130 allows the sponsor 30 to enter at least one recipient 12 for listing on the donation management system 10. In one form, the recipient designation web page 130 includes a plurality of recipient designation selections 132 that allow the sponsor 30 to designate the number of recipients 12 that they would like to sponsor for the purpose of soliciting donations. Selection by the sponsor 30 of one of these recipient designation selections 132 indicates the number of recipients 12 for which the sponsor 30 would like to solicit donations.

In this form, the sponsor 30 can select from three different options. The first option allows the sponsor 30 to designate one recipient 12. The second option allows the sponsor 30 to designate up to ten recipients 12. The third option allows the sponsor 30 to designate up to twenty-five recipients 12. As illustrated in FIG. 5a, the sponsor 30 is charged a predetermined sum of $30.00 under the first option, a sum of $250.00 ($25.00/recipient) under the second option, and a sum of $500.00 ($20.00/recipient) under the third option. As such, as more recipients 12 are sponsored, the cost associated with the sponsorship becomes discounted. Under the second and third options, additional recipient data fields 134 are provided that allow the sponsor 30 to designate more recipients 12 at the discounted rate. For example, the sponsor 30 may designate four additional recipients 12 under the second option at a rate of $25.00 per additional recipient 12. As illustrated, in this form each recipient 12 entered by the sponsor 30 will have a listing for a predetermined period of time, which in this example is thirty days.

The recipient designation web page 130 also includes a recipient first name data field 136, a recipient last name data field 138, a recipient city data field 140, a recipient state data field 142, a recipient zip code data field 144, and a recipient email data field 146. The sponsor 30 will enter the information or data for the recipient 12 in each of these respective data fields. The recipient email data field 146 is an optional entry.

A photo or image upload data field 148 is included that is automatically populated once the user designates an image 150 to be uploaded to the donation management system 10. A selection button 152 allows the sponsor 30 to select the image 150 to be uploaded to the donation management system 10 from the sponsor terminal 18. The image 150 could be a picture of the recipient or the recipient's family or any other type of image that the sponsor 30 may choose to upload. As set forth in greater detail below, the image 150 is placed on a web page that is created to solicit funds for the recipient 12. A personal summary data field 154 is included that allows the sponsor 30 to enter personal information regarding the recipient 12 and the recipient's life altering event for which funds are being solicited.

A plurality of donation fund transfer options 156 are provided that allow the sponsor 30 to designate how the donated funds that are received are transferred to the recipient 12. In the form illustrated in FIG. 5a, the sponsor 30 has selected to transfer the donations received to the recipient 12 via an electronic direct deposit into a designated bank account of the recipient 12. In that regard, a bank name data field 158 is provided so that the sponsor 30 can enter the name of the bank that will receive the funds. An account name data field 160 is provided so that the sponsor 30 can enter the recipient's name. A routing number data field 162 is provided so that the sponsor 30 can enter the routing number of the bank or financial institution. An account number data field 164 is also provided so that the sponsor 30 can enter the account number to which the funds will be electronically deposited. Once the time period for the listing has expired, the fund processing server 26 is configured to electronically deposit all funds contained in the recipient donation account 302 to the designation account via the financial institution server 28.

Once all of the information has been entered by the sponsor 30 on the recipient designation web page 130, a submit button 166 is provided that once selected will transmit all of the information entered in the various data fields, as well as the image 150 to be uploaded, back to the web server 40. The recipient module 52 then stores all of this information as well as the image 150 in a recipient database 168 located on the database server 42. If the sponsor 30 has selected to sponsor more than one recipient 12, then the recipient module 52 is configured to generate another recipient designation page 130 on the web browser 20 and the process continues until all recipient information has been entered and stored in the recipient database 168. The recipient designation selections 132 will not be generated on these subsequent web pages.

Referring to FIG. 5b, in this illustrative form the sponsor 30 has selected under the donation fund transfer option 156 to pay the recipient the donated funds by a check. As such, a name data field 170, a street address data field 172, a city data field 174, a state data field 176, and a zip code data field 178 are provided so that the sponsor 30 can enter the information required to issue and mail the check to the recipient 12. Upon selection of the submit button 166 this information is transmitted back to the web server 40 and stored in the recipient database 168. Once the listing period has expired, the sponsor 30 instructs the fund processing server 28 to issue a check to the recipient 12 that transfers all donations from the recipient donation account 302 to the recipient 12.

Referring to FIG. 5c, in this illustrative form the sponsor 30 has selected under the donation fund transfer option 156 to pay the recipient by transferring the funds to an electronic account 157 (e.g.—a Paypal account setup at www.paypal.com) of the recipient 12 that has been set up or created on the fund processing server 26. See FIG. 1. In order for the funds to be transferred in this manner, the sponsor 30 would need to enter an electronic account identification 180 associated with the recipient 12 in an electronic account identification data field 182. Again, upon selection of the submit button 166 this information is transmitted back to the web server 40 and stored in the recipient database 168. Once the listing period has expired, the sponsor 30 instructs the fund processing server 28 to transfer all donated funds from the recipient donation account 302 to the recipient account 157.

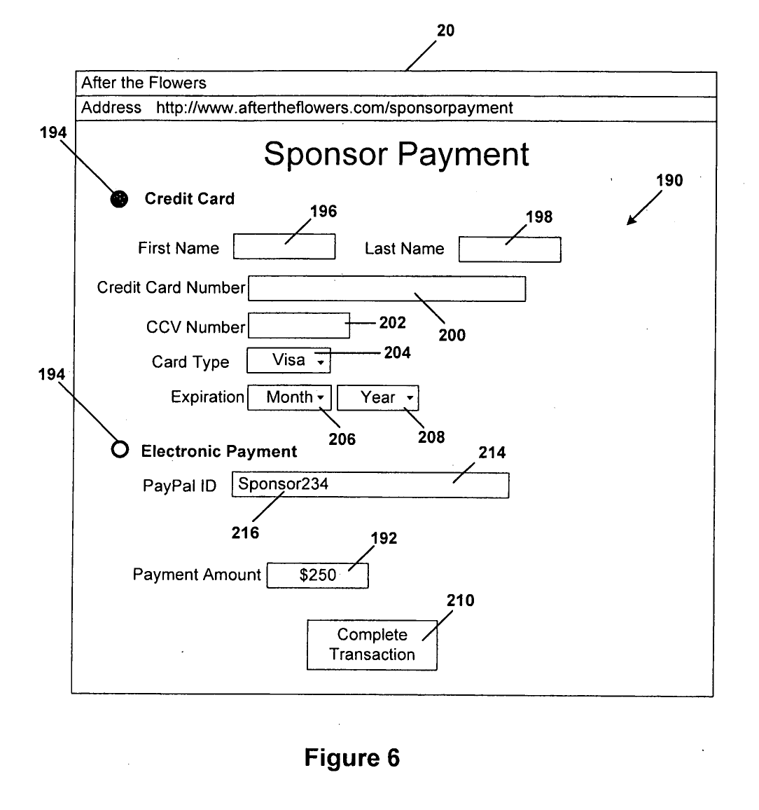

Referring to FIGS. 2 and 6, once all of the recipients 12 information has been entered by the sponsor 30, the payment module 54 is executed which generates and transmits a payment web page 190 on the web browser 20. The payment module 54 is configured to automatically total the amount to be charged as a function of the total number recipients 12 entered by the sponsor 30 and the associated rate being charged based on the option selected by the sponsor 30. In this illustrative example, the sponsor 10 has selected the second option of sponsoring ten recipients 12 and as such, a charge display field 192 is generated on the payment web page 190 setting forth how much the sponsor 30 is being charged for listing ten recipient 12.

In this illustrative form, the payment web page 190 includes two payment options 194 that the sponsor 30 may choose from to pay the charges. The first payment option 194 is for the sponsor 30 to pay by a credit card or debit card. As such, a first name data field 196, a last name data field 198, a credit card number data field 200, a card code verification (CCV) data field 202, a card type selection field 204, a expiration month selection field 206, and an expiration year selection field 208 are provided for the sponsor 30 to make a payment. Upon entry of all of the information in these respective data fields and selection of a complete transaction button 210, the information is transmitted back to the payment module 54. With this form of payment, the payment module 54 is configured to automatically charge the amount indicated in the payment display field 192 to the credit/debit card entered by the sponsor 30.

The second payment option 194 is for the sponsor 30 to pay using an electronic sponsor account 212 (See FIG. 1) that the sponsor 30 has set up on the fund processing server 26. An electronic fund payment data field 214 is provided that allows the sponsor 30 to enter a user ID 216 that is associated with their account 212. Upon selection of the complete transaction button 210, the sponsor 30 is temporarily redirected by the payment module 54 to the fund processing server 26 to complete the transaction. In this form, the payment is transferred from the sponsor account 212 to a donation management account 214 that is associated with the proprietor of the donation management system 10.

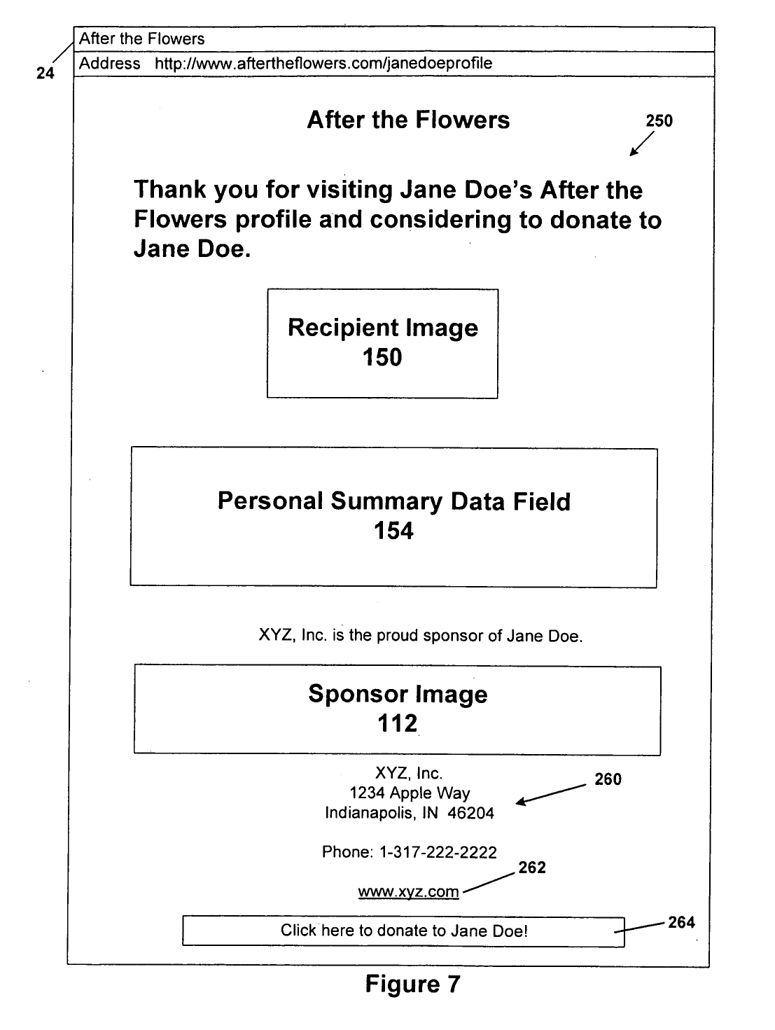

Once the sponsor 30 has paid for listing a respective recipient 12, the recipient web page creation module 56 is configured to automatically generate a recipient fund solicitation web page or listing 250. See FIG. 7. In one form, the recipient web page creation module 56 accesses one or more predefined templates 251 contained in a template database 252 located or stored on the database server 42 to create the recipient fund solicitation web page 250. See FIG. 2. Each recipient 12 that was added by the sponsor 30 is also added to a list of recipients that is stored in the recipient database 168 and associate with that sponsor 30.

As illustrated in FIG. 7, the recipient fund solicitation web page 250 can have several textual passages and may take many different forms. The intent of the recipient fund solicitation web page 250 is to provide information on the recipients 12 life changing event to potential donors 14 so that they will donate to the recipient 12. In one form, the recipient fund solicitation web page 250 displays the recipient image 150 that was uploaded by the sponsor 30 during the setup process. In addition, the recipient fund solicitation web page 250 also displays the personal summary data that was entered in the personal summary data field 154 by the sponsor 30 during the setup process. As such, in this form the recipient fund solicitation web page 250 is created as a function of at least one template 251, the recipient image 150, and data entered in the personal summary data field 154.

In another representative form, the recipient fund solicitation web page 250 includes the sponsor image 112 that was uploaded by the sponsor 30 during the registration or setup process. In addition, the organization name that was entered in the organization name data field 84 as well as the organization address and contact information provided in data fields 84, 92, 94, 96, 98, 100, and 102 can be automatically populated or placed on the recipient fund solicitation web page 250 in a sponsor contact display field 260. Further, a sponsor hyperlink 262 to a website 116 of the sponsor 30 that was provided in the website URL data field 106 during the registration process can also automatically be placed on the recipient fund solicitation web page 250. Selection of the sponsor hyperlink 262 will redirect the web browser 24 of the donor 14 to the sponsor website 116.

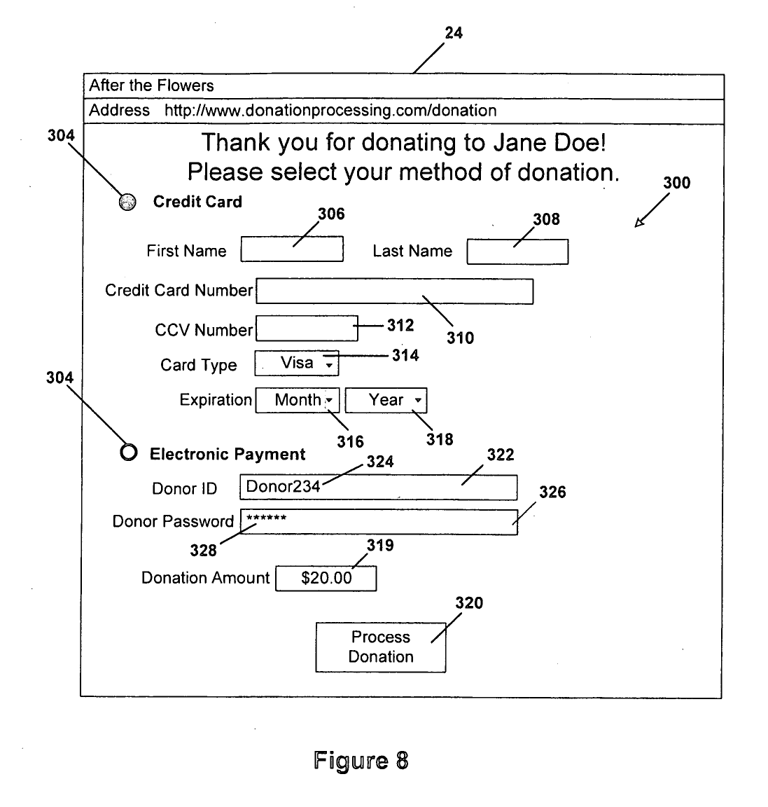

One or more donation selection buttons 264 are placed on the recipient fund solicitation web page 250 that allow perspective donors 14 to donate funds to the recipient 12. In one form, selection of a respective donation selection button 264 will cause the donation module 68 to automatically redirect the donor 14 to a donation payment web page 300 that is generated by either the web server 40 or the fund processing server 26. See FIG. 8. In addition, the donation module 68 will automatically transmit recipient data to the fund processing server 26 that identifies the recipient 14 of the donation as well as the recipient donation account 302 to which the funds are to be deposited. As previously set forth, all sponsors 30 are required to setup or create a recipient donation account 302 on the fund processing server 26 for the purpose of receiving and maintaining all of the funds that are donated to each recipient 14. All funds donated to each respective recipient 14 will be credited to the recipient donation account 302 and not to any other account.

In this illustrative form, the donation payment web page 300 includes two payment options 304 that the donor 14 may choose from. The first donation payment option 104 is for the donor 14 to make the donation by a credit card or debit card. As such, a first name data field 306, a last name data field 308, a credit card number data field 310, a card code verification (CCV) data field 312, a card type selection field 314, a expiration month selection field 316, and an expiration year selection field 318 are provided for the donor 14 to make a donation of funds. A donation amount data field 319 is included that allows the donor to indicate the amount of money (e.g.—$20.00) the donor 14 would like to donate to the recipient 12. Upon entry of all of the information in these respective data fields and selection of a process donation button 320, the donation is processed by the fund processing server 26 and the funds are credited to the recipient donation account 302.

In yet another form, a second donation payment option 304 is for the donor 14 to make the donation by using a donor electronic account 111 (See FIG. 1) that the donor 14 has set up on the fund processing server 26. A donor user ID data field 322 is provided that allows the donor 14 to enter a user ID 324 that is associated with their account 111. A password data field 326 is provided that allows the donor 14 to enter a password 328 that is associated with the donor account 111. Upon selection of the process donation button 320, the donation made is credited by the fund processing server 26 to the recipient donation account 302. It is important to note that the recipients 12 will not know who contributed donations or what amounts were contributed by donors. All contributions made to the recipients 12 by the donors 14 are maintained in confidence.

Referring back to FIG. 2, in order for donors 14 to find recipients 12 to whom they would like to donate, the main page 60 includes a recipient search area 72 and a sponsor search area 74. This allows donors 14 to search for recipients 12 by searching for either recipients 12 or sponsors 30. For instance, some donors 14 may want to donate to a particular individual while other donors 14 may want to donate to an individual that has been sponsored by a respective sponsor 30. The donation management system 10 is configured to allow potential donors 14 to easily locate recipients 12 to whom they would like to donate.

In one form, the web server 40 includes a recipient search module 64 that is configured and operable to search the recipient database 168. The main page 60 can include a recipient name data field 350, a recipient address data field 352, a recipient city data field 354, a recipient state data field 356, and a recipient zip code data field 358. A potential donor can enter information in any of these respective fields to locate recipients 12 that satisfy any criteria (i.e.—name, city, state, zip code). This provides donors 14 with a powerful search tool that will allow them to quickly and easily identify potential recipients 12. Selection of a search button 360 by the donor 14 causes the recipient search module 64 to conduct a search of the recipient database 168 for recipients that satisfy the search parameters that are entered by the donor 14 in at least one of the respective search fields set forth above.

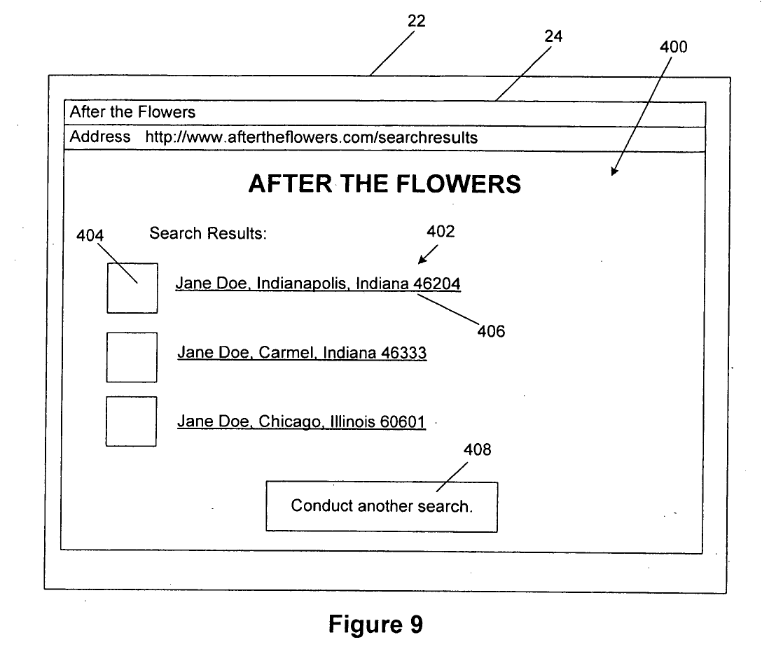

Referring to FIG. 9, the recipient search module 64 is configured to automatically generate a search results web page 400 that contains a hyperlinked listing 402 of all recipients 12 contained in the recipient database 168 that satisfy the search criteria. In this illustrative example, the recipient search module 64 returned all results for “Jane Doe” that were located in the recipient database 168. In one form, the recipient search module 64 is configured to generate a thumbnail image 404 of the recipient image 150 that was provided by the sponsor 30. Selection of a result 406 in the hyperlinked listing 402 will cause the recipient donation solicitation web page 250 of the selected recipient 12 to be generated on the web browser 24 of the donor 14. A conduct another search button 408 can be included that will direct the donor 14 back to the main page 60 to conduct another search.

In yet another form, the web server 40 includes a sponsor search module 68 that is configured and operable to search the sponsor registration database 124. Referring to FIG. 3, the main page 60 can include a sponsor or entity name data field 362, a sponsor address data field 364, a sponsor city data field 366, a recipient state data field 368, and a recipient zip code data field 370. A potential donor 14 can enter information in any of these respective fields to locate sponsors 30 that satisfy any criteria (i.e.—name, city, state, zip code). This provides donors 14 with a powerful search tool that will allow them to quickly and easily identify sponsors 30 that have listings. Selection of a search button 372 by the donor 14 causes the sponsor search module 66 to conduct a search of the sponsor registration database 124 for sponsors 30 that satisfy the search parameters that are entered by the donor 14 in at least one of the respective search fields set forth above.

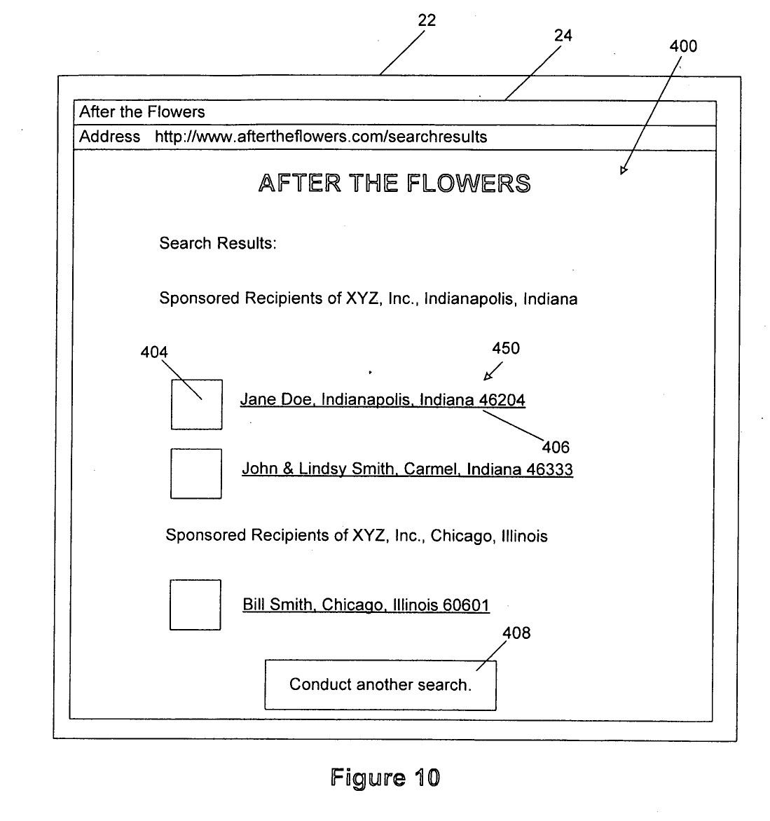

Referring to FIG. 10, the sponsor search module 66 is configured to search the sponsor registration database 124 to locate any entity that satisfies the search parameters entered by the donor 14. For example, in the illustrative example set forth in FIG. 10 a search was conducted for a business entity named “XYZ” and the sponsor search module 66 searched the sponsor registration database 124 and located every sponsor 30 with that name. In this example, there were two business entities that were registered with the donation management system 10 that were currently actively sponsoring one or more recipients. In addition, the sponsor search module 66 is configured to search the recipient database 168 to obtain a listing of active recipients 14 that these respective sponsors 30 were currently sponsoring.

As with the recipient search module 64, the sponsor search module 66 is configured to generate a recipient hyperlink list 450 that displays each respective recipient 12 that each sponsor 30 is sponsoring. The recipient hyperlink list 450 is created such that each recipient 12 falls under each respective sponsor 30. In one form, the sponsor search module 66 is configured to generate a thumbnail image 404 of the recipient image 150 that was provided by the sponsor 30. Selection of a result 406 in the hyperlinked listing 402 will cause the recipient donation solicitation web page 250 of the selected recipient 12 to be generated on the web browser 24 of the donor 14. A conduct another search button 408 can be included that will direct the donor 14 back to the main page 60 to conduct another search.

Referring back to FIG. 2, as previously set forth, each listing that is provided by a sponsor 30 is active for a predetermined period of time. Although the illustrative form sets forth a thirty day listing, other time periods may be used in other forms of the present invention. At the end of the listing period, the donation module 68 is configured to generate an email that is sent to the sponsor email address provided in the sponsor email data field 102 during registration. In this example, the donation module 68 will send an email to “Jdoe@xyz.com” that informs the sponsor 30 that the listing period has expired and that the sponsor needs to transfer all proceeds to the recipient 12.

In on representative form, all sponsors 30 are required to list the proprietor of the donation management system 10 as a secondary on any recipient donation account 302 that is created for receiving donations. However, in other forms, the sponsors 30 are not required to list the proprietor of the donation management system 10 as a secondary on recipient donation accounts 302. In addition, as previously set forth, the sponsors 30 are also required to provide the donation processor user ID 108 and donation processor password 110 associated with the recipient donation account 302 to the donation management system 10. This allows the proprietor of the donation management system 10 to ensure that all funds donated are transferred to the recipient 12 using the method designated during the registration and setup process previously discussed. All funds donated by donors 14 must pass directly to the recipients 12. Neither the sponsor 30 nor the proprietor of the donation management system 10 retain or keep any donated funds. If, after a predetermined period of time, the sponsor 30 has not transferred the funds to the recipients 12, the proprietor of the donation management system 10 shall have the right to transfer all of the funds from the recipient donation account 302 to the designated recipient 14.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. A system, comprising:
a donation server in communication with a network, wherein said donation server includes a sponsor registration module, a sponsor payment module and a recipient web page creation module;
a sponsor terminal in communication with said network that includes a sponsor web browser;
a donor terminal in communication with said network that includes a donor web browser;
a donation processing server in communication with said network configured to receive funds donated to a recipient and transfer funds to said recipient after a predetermined period of time;
wherein said sponsor web browser is configured to access said sponsor registration module, wherein upon activation of said sponsor registration module a sponsor registration web page is transmitted to said sponsor web browser from said donation server that is configured to allow a sponsor to register and sponsor one or more respective recipients, wherein said sponsor registration module is configured such that only a legal business entity is allowed to sponsor a respective recipient for receipt of donations, and
wherein said sponsor registration module is configured to generate a recipient designation web page on said sponsor web browser upon completion of sponsor registration, wherein said recipient designation web page includes a plurality of recipient designation selections configured to allow said sponsor to designate one or more recipients that said sponsor desires to sponsor, a plurality of recipient information data input fields configured to receive inputs from said sponsor about said recipient, a recipient upload image data input field configured to allow said sponsor to upload an image associated with said recipient, a personal summary data input field configured to allow said sponsor to input a short summary of a life altering event associated with said recipient, and a plurality of donation fund transfer method data input fields configured to allow said sponsor to designated the manner in which donated funds are transferred to said recipient.

2. The system of claim 1, wherein said sponsor registration web page includes a type of organization data input field, an organization name data input field, a plurality of sponsor information data input fields, a sponsor username data input field, a sponsor password data input field, and a sponsor image upload data field, wherein said sponsor image upload data field is configured to allow said sponsor to upload a sponsor image to said donation server.

3. The system of claim 2, wherein said sponsor registration page includes a sponsor website URL data input field.

4. The system of claim 1, wherein said plurality of donation fund transfer method data input fields include a bank account transfer selection, a check payment selection, and an electronic third-party account transfer selection.

5. The system of claim 1, wherein said recipient designation web page is configured to execute said sponsor payment module, wherein said sponsor payment module is configured to transmit a sponsor payment web page to said sponsor web browser, wherein said sponsor payment web page includes a transaction card payment option and an electronic account payment option.

6. The system of claim 5, wherein after said sponsor pays said sponsor payment module is configured to execute said recipient web page creation module, wherein said recipient web page creation module is configured to automatically generate a recipient fund solicitation web page.

7. The system of claim 6, wherein said recipient fund solicitation web page includes said image associated with said recipient, said data input by said sponsor in said personal summary data input field, said sponsor image, a sponsor contact display field, and a hyperlink to a website of said sponsor.

8. The system of claim 6, wherein said recipient fund solicitation web page includes a donation selection item that is configured to execute a donation module.

9. The system of claim 8, wherein said donation module is configured to generate a donation payment web page on said donor web browser.

10. The system of claim 9, wherein said donation payment web page includes a plurality of payment options including a transaction card payment option and an electronic transfer payment option.

11. The system of claim 10, wherein upon selection and completion of a respective payment option said donation module is configured to automatically transfer donated funds to a recipient account.

12. The system of claim 11, wherein said recipient account is located on a third party donation processing server in communication with said network.

13. A system, comprising:
a donation server in communication with a network;
a sponsor terminal in communication with said network having a sponsor web browser; and
wherein said donation server includes a sponsor interface module configured to transmit one or more web pages to said sponsor web browser in response to requests from said sponsor terminal; wherein said sponsor interface module includes a sponsor registration module, a sponsor payment module, and a recipient web page creation module; wherein said sponsor registration module is configured to allow a sponsor to register one or more recipients for the purpose of soliciting donations for said recipients from donors; wherein said sponsor registration module is configured such that only business entities can sponsor said one or more recipients; wherein said sponsor payment module is configured to charge said sponsor for sponsoring said one or more recipients; and wherein said recipient web page creation module is configured to automatically a recipient donation web page in response to inputs entered by said sponsor.

14. The system of claim 13, wherein said sponsor registration module includes a plurality of contact information data input fields, a sponsor image upload data input field, and a website URL data input field, wherein said sponsor contact information entered in said contact information data input fields, said sponsor image provided through said sponsor image upload data input field, and a sponsor website URL entered in said website URL data input field are transmitted to said donation server and stored in a sponsor database.

15. The system of claim 14, wherein said sponsor registration module is configured to generate a recipient designation web page on said sponsor web browser, wherein said recipient designation web page includes one or more recipient designation selections configured to allow said sponsor to designate a number of recipients said sponsor wants to sponsor, wherein said recipient designation web page includes a plurality of recipient information data input fields configured to allow said sponsor to enter information about said one or more recipients.

16. The system of claim 15, wherein said recipient designation web page includes an upload recipient image data input field configured to allow said sponsor to upload a recipient image, wherein said recipient designation web page includes a personal summary data input field configured to allow said sponsor to enter a description of a life altering event being experienced by said recipient.

17. The system of claim 16, wherein said recipient designation web page includes a donation fund transfer method data input field configured to allow said sponsor to designate how donated funds are to be transferred to said recipient.

18. The system of claim 17, wherein recipient data entered in said plurality of recipient information data input fields, said recipient image uploaded via said upload recipient image data input field, said personal summary entered in said personal summary data input field, and said transfer method entered in said donation fund transfer method data input field are transmitted to said donation server and stored in a recipient database.

19. The system of claim 18, wherein said recipient web page creation module is configured to automatically generate a recipient listing as a function of said recipient image, said personal summary, said sponsor image, said sponsor contact information, and said sponsor website URL.

20. The system of claim 19, further comprising a donor terminal connected with said network including a donor web browser, wherein said recipient listing comprises a recipient web page that includes a donation selection button configured to allow one or more donors to donate funds to said recipient, wherein upon selection of said donation selection button a donation payment web page is generated on said donor web browser, wherein said donation payment web page is configured to conduct a transaction in which funds are transferred from a designated donor financial account to a recipient financial account created by said sponsor.

21. The system of claim 20, wherein after a predetermined period of time donated funds are transferred from said recipient financial account to said transfer method designated in said donation fund transfer method data input field.
